(19) United States
(12) Patent Application Publication
(10) Pub. No.: US 2018/0072606 A1
(43) Pub. Date: Mar. 15, 2018

(54) MANUFACTURING METHOD OF 3D GLASS

(71) Applicant: KEY APPLICATION TECHNOLOGY CO., LTD., Zhudong Township (TW)

(72) Inventors: Chien-Yu Chou, New Taipei City (TW); Ya-Ting Chang, Taichung City (TW)

(21) Appl. No.: 15/261,992

(22) Filed: Sep. 11, 2016

(51) Int. Cl. C03B 23/035; C03B 33/09; C03C 21/00

(52) U.S. Cl. CPC C03B 23/0357; C03B 33/091; C03C 21/002; C03C 2218/112; C03B 2215/22; C03C 2217/73; C03B 2215/06

(57) ABSTRACT

A manufacturing method of 3D glass includes steps of precutting and drilling a 2D glass substrate by means of perfect laser cleaving and using a complex molding equipment to process and mold a 3D glass object with 3D curved structure. By means of the manufacturing method of 3D glass, the structural strength of the 3D glass object is enhanced. In addition, a 3D glass product with special surface texture or morphology can be produced. Also, the defective ratio in the manufacturing process can be lowered.

### BACKGROUND OF THE INVENTION

### 1. Field of the Invention

The present invention relates generally to a manufacturing method of 3D glass, and more particularly to a manufacturing method of 3D glass, which can enhance the strength of 3D glass products of a handheld or mobile device and can produce 3D glass product with special surface texture or morphology. In addition, by means of the manufacturing method of 3D glass, the defective ratio in the manufacturing process is lowered.

### 2. Description of the Related Art

The current 3D glass cover plate is mainly processed, such as cut or drilled by means of CNC machine. The glass itself has a characteristic of fragility. Therefore, when using the CNC machine to process, such as cut or drill the glass, it is easy to produce a broken or chipped defective product. Some manufacturers use common laser cleaving instead of the CNC machine. The current laser cleaving can be substantially classified into two types, that is, ablation and stealth dicing. The former is to concentrate the laser energy onto a micro-area of the surface of the glass in very short time so as to evaporate the glass. However, the common laser cleaving has some shortcomings. For example, the edges are often molten and cannot be removed from the glass substrate. The latter is to focus laser beam inside the glass to form an affected layer without forming cutting trace on the surface of the glass.

The current 3D glass cover plate with curved surface is mainly made by a male mold section and a female mold section in thermal pressing manner. The male and female mold sections are pressed and mated with each other at a certain temperature (generally between transition temperature and soft point). The glass substrate enters the space between the female and male mold sections to be molded into the 3D cover plate. The thermal molding machine of the male and female mold sections can only molds the glass at the transition temperature of the glass. The molding at a temperature approximate to or higher than the soft point (around 800° C.) will greatly shorten the lifetime of the mold. In addition, it is hard to control the uniformity of the size (mainly the thickness) of the molded product.

Moreover, due to the lower molding temperature and the limitation of the equipment, it is impossible to achieve a good mold-duplicate rate. (For example, it is impossible to produce a product with a sandblasted surface, hairline surface, recessed/raised characters or a designed logo on the surface of the product). There is another well known shortcoming. That is, in the manufacturing process, the larger the glass contact area is, the higher the possibility of scratch or collision of the glass is. Furthermore, the male and female mold sections are made of graphite material. The impurities and vents in the graphite will all increase the possibility of production of defective products in the molding process.

The other difficulty encountered by the 3D glass product is to decorate the 3D curved surface. For example, the glass of a common mobile phone needs black or white ink as decoration. Such decoration can be hardly achieved on the 3D glass. This is because the ink cannot be applied to the 3D surface by means of the traditional screen printing or pad printing technique. The ink can be only first sprayed onto the curved surface of the glass and then cured. Thereafter, the ink is removed by means of laser engraving. Alternatively, a photosensitive ink/photoresistant is sprayed over the entire surface and then the unneeded area is removed by means of exposure development technique.

According to the above, the conventional manufacturing method of 3D glass has the following shortcomings that need to be improved:

1. How to precisely cut 2D glass to facilitate the successive size control of the molded 3D glass.

2. The thermal molding machine must be co-used with a graphite or alloy mold.

3. How to complete the exposure or laser engraving process with one equipment.

### SUMMARY OF THE INVENTION

It is therefore a primary object of the present invention to provide a manufacturing method of 3D glass cover plate.

To achieve the above and other objects, the manufacturing method of 3D glass of the present invention includes steps of:

providing a 2D glass substrate and precutting and drilling the 2D glass substrate by means of perfect laser cleaving;

placing the 2D glass substrate into a 3D thermal molding equipment for molding to form a 3D glass object; and

taking out the molded 3D glass object from the 3D thermal molding equipment.

By means of the manufacturing method of 3D glass of the present invention, the structural strength of the 3D glass object is enhanced and the defective ratio in the manufacturing process is lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart of a first embodiment of the manufacturing method of 3D glass of the present invention;

FIG. 2 is a schematic diagram of the first embodiment of the manufacturing method of 3D glass of the present invention;

FIG. 3 is a schematic diagram of the first embodiment of the manufacturing method of 3D glass of the present invention;

FIG. 4 is a schematic diagram of the first embodiment of the manufacturing method of 3D glass of the present invention;

FIG. 4a is a curve diagram of glass viscosity of the first embodiment of the manufacturing method of 3D glass of the present invention;

FIG. 5 is a flow chart of a second embodiment of the manufacturing method of 3D glass of the present invention;

FIG. 6 is a flow chart of a third embodiment of the manufacturing method of 3D glass of the present invention;

FIG. 7 is a schematic diagram showing the processing procedure of the third embodiment of the manufacturing method of 3D glass of the present invention;

FIG. 8 is a flow chart of a fourth embodiment of the manufacturing method of 3D glass of the present invention; and

FIG. 9 is a schematic diagram of a fifth embodiment of the manufacturing method of 3D glass of the present invention.

### DETAILED DESCRIPTION OF THE PREFERRED EMBODIMENTS

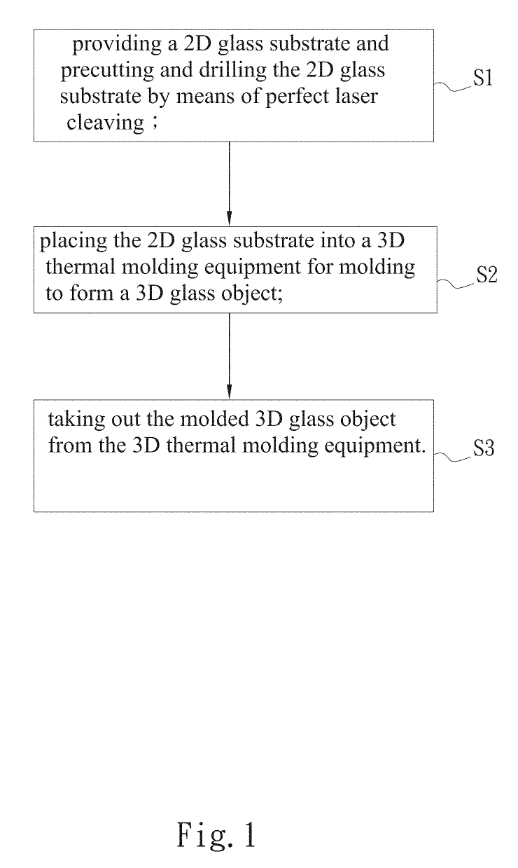

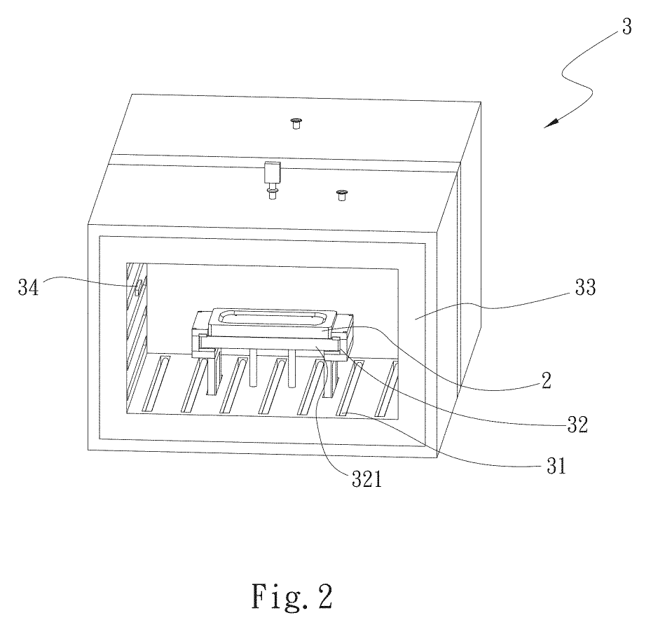

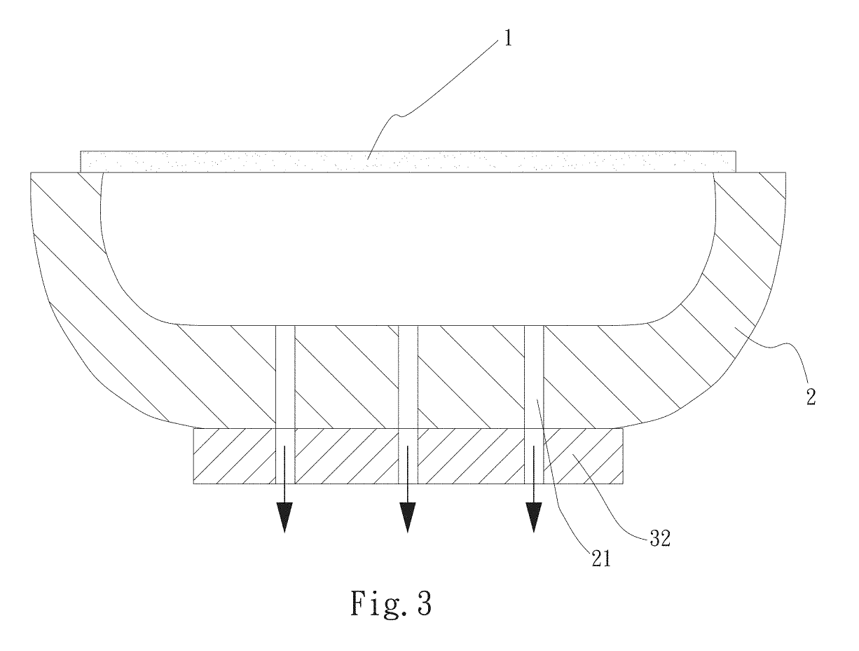

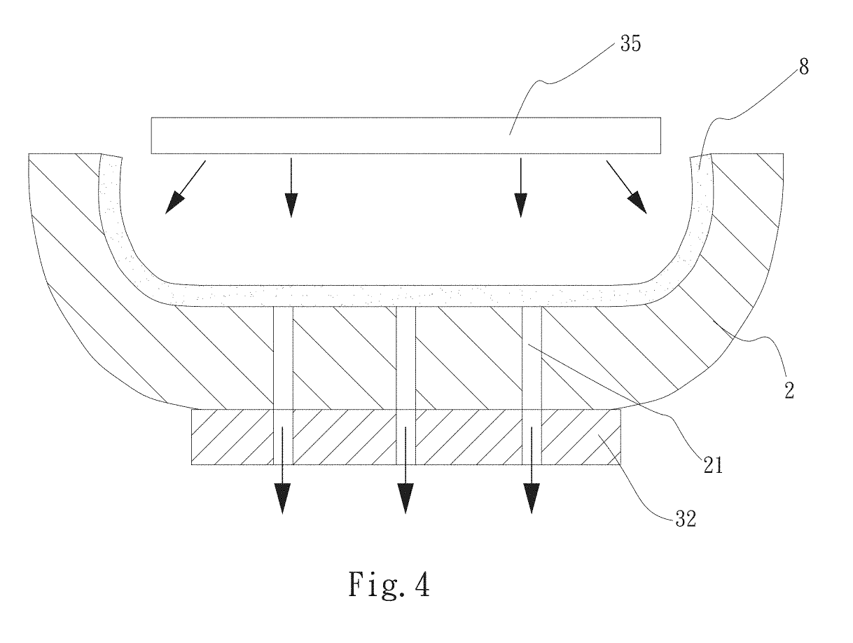

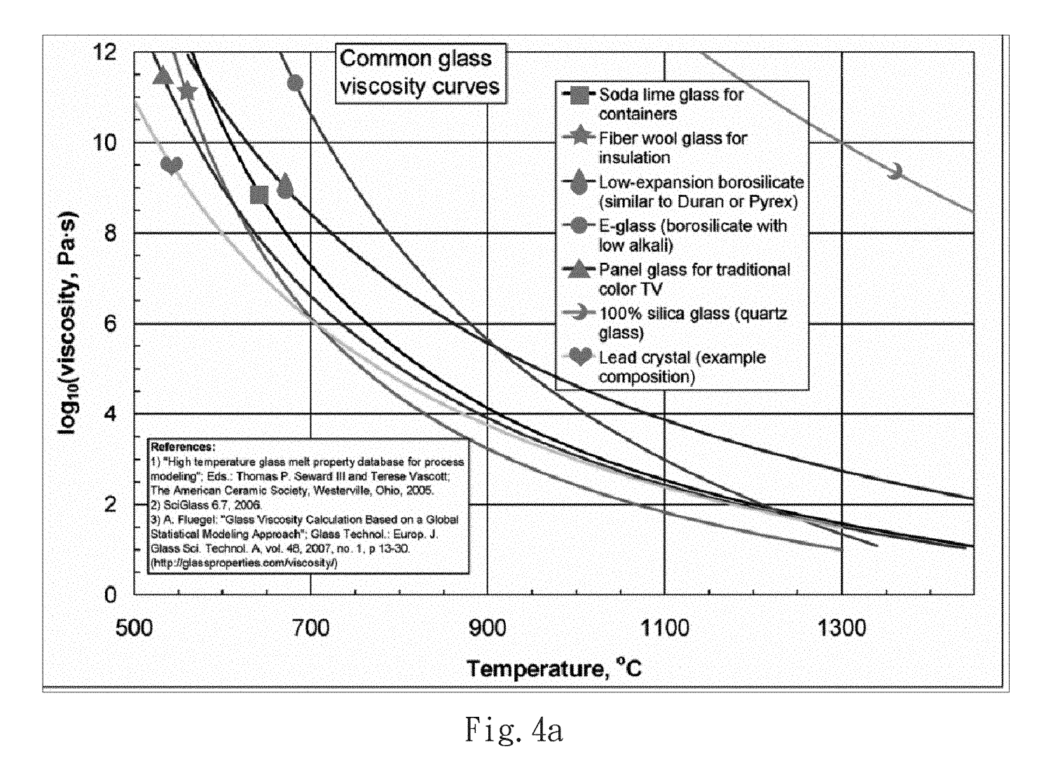

Please refer to FIGS. 1, 2, 3, 4 and 4a. FIG. 1 is a flow chart of a first embodiment of the manufacturing method of 3D glass of the present invention. FIG. 2 is a schematic diagram of the first embodiment of the manufacturing method of 3D glass of the present invention. FIG. 3 is a schematic diagram of the first embodiment of the manufacturing method of 3D glass of the present invention. FIG. 4 is a schematic diagram of the first embodiment of the manufacturing method of 3D glass of the present invention. FIG. 4a is a curve diagram of glass viscosity of the first embodiment of the manufacturing method of 3D glass of the present invention. According to the first embodiment, the manufacturing method of 3D glass of the present invention includes steps of:

S1. providing a 2D glass substrate 1 and precutting and drilling the 2D glass substrate 1 by means of perfect laser cleaving, a commercially available 2D glass substrate being provided, the glass substrate being first drilled or cut by means of perfect laser cleaving, when cutting and drilling the glass substrate, it is necessary to take the size of the formed 3D glass into consideration, including the expansion/contraction of the glass and the solid obstruction phenomenon of the product and the mold so as to avoid the situation that the molded product cannot be demolded or is broken due to solid obstruction, the perfect cleaving being an application of ultrashort pulse laser, the width of the kerf being minimized to zero so that the cutting precision is extremely high and much higher than the ability of mechanical processing machine and any other traditional laser, the perfect cleaving technique being used to cleave the glass from its interior, while keeping the surface clean and smooth without any slag sputtering, this being quite different from the conventional laser cleaving and able to improve the problems of such as crack and deterioration of structural strength that happen when using the conventional CNC processing machine to process the 2D glass substrate, the drilling process needing to cooperatively use common laser ablation to remove the residual material, the sort of laser including CW/Plus Type with a wavelength of UV (355 nm) or IR (1064 nm), during the perfect laser cleaving process, the laser beam with a glass-passable wavelength being focused by a lens onto a point, the laser beam then scanning along a cleaving line, the optical system used here having very high focusing ability and being able to compress the laser beam to diffraction limit, accordingly, in time and space, the high-repetition short-pulse laser beam being compressed to a very small area near the focus and having very high peak value power density, during the compression process of the glass-passable laser beam, when the peak value optical energy density exceeds a certain divergence value, a high absorptivity of glass to the laser beam appearing so that the divergence value of the optical density can be better controlled by means of optimizing the optical system and the characteristic of the laser beam to achieve the object that the peak value optical energy density exceeds the divergence value only inside the glass and near the focus, the adjustment of the divergence value being describable with the laser beam as Gaussian beam, the focusing of the laser beam being limited by the diffraction limit (as the following diffraction limit formula), when the laser beam is diverged, a smaller focus being achieved and higher energy density and processing precision being obtained, however, at this time, the depth of focus becoming shallower (as the following depth of focus formula), in this case, only shallow layer processing being performable, when processing a thicker object, in case of same precision of processing, only the laser beam with shorter wavelength being usable to achieve the object, accordingly, in a specified laser condition (laser beam diameter, transverse mode and laser beam quality M2 value), by means of elongating the depth of focus or multi-focus diffraction grating and using a lens to focus, the depth of focus being elongated in the size of the focus under the diffraction limit, in this case, the laser beam being usable to selectively process certain sections inside the glass without damaging the surface and edges of the glass, an affected layer being formed in the laser beam processed area as a crack start point, the crack becoming vertically longer to up and down extend between the front and rear surfaces of the glass, the perfect laser cleaving serving to cleave the object material inside, this being totally different from the ordinary laser cleaving that cleaves the glass outside, the diffraction limit formula being as follows:

$$\frac{4 \times L \times λ}{π \times D} \times {M}^{2} = D . L . Spot size$$

where L is focal length, λ is wavelength, D is diameter of incident beam, M2 is laser beam quality, and D.L. Spot size is focus size, the depth of focus formula being as follows:

$$\frac{2 λ}{π} \times {( \frac{L}{D \text{/} 2} )}^{2} = D . O . F .$$

Where L is focal length, λ is wavelength, D is diameter of incident beam, and D.O.F. is depth of focus;

S2. placing the 2D glass substrate 1 into a 3D thermal molding equipment 3 for molding to form a 3D glass object 8, the 2D glass substrate being placed into a graphite mold with surface coating to heat the 2D glass substrate, viscous flow of glass material (non-Newtonian fluid) being a thermally activated process, where Q is activation energy, T is temperature, R is the molar gas constant and A is approximately a constant, the viscous flow in amorphous materials being characterized by a deviation from the Arrhenius-type behavior: Q changes from a high value Q_{H} at low temperatures (in the glassy state) to a low value Q_{L} at high temperatures (in the liquid state), depending on this change, amorphous materials being classified as either
strong when: Q_{H}−Q_{L}<Q_{L} or
fragile when: Q_{H}−Q_{L}≧Q_{L}.

μ=A₁·T·[1+A₂·e^{B/RT}]·[1+C·e^{D/RT}]

the viscosity of amorphous materials being quite exactly described by a two-exponential equation with constants A₁, A₂, B, C and D related to thermodynamic parameters of joining bonds of an amorphous material, not very far from the glass transition temperature, T_{g}, this equation can be approximated by a Vogel-Fulcher-Tammann (VFT) equation, if the temperature being significantly lower than the glass transition temperature, T<<Tₛ, then the two-exponential equation simplifies to an Arrhenius-type equation:

μ=A_{L}T·e^{Q}^{_{H}}^{/RT}

with:

Q_{H}=H_{d}+Hₘ

where H_{d} is the enthalpy of formation of broken bonds (termed configuron s) and Hₘ is the enthalpy of their motion, when the temperature is less than the glass transition temperature, T<T_{g}, the activation energy of viscosity being high because the amorphous materials being in the glassy state and most of their joining bonds being intact, when the temperature is higher than the glass transition temperature, T>T_{g}, the activation energy of viscosity being low because amorphous materials are melted and have most of their bonds broken, which facilitates flow, the formation temperature being determined by the shape of the 3D glass product, for example, 2-side folding 3D glass can be achieved at high viscosity, reversely, a product requiring complicated surface, such as a 3D product with sandblasted or hairline surface needs to be formed in a lower viscosity state, the 3D thermal molding equipment further having a mold 2, the surface of the mold 2 being processed into sandblasted surface, hairline surface, laser stripes, various recessed/raised characters and logo, with respect to those sections of the 2D glass substrate 1 being molded to form the 3D glass object 8 that have non-uniform thickness or the bent corner sections, a device being used to provide non-contact depressing force to tightly attach the glass to the mold, by means of controlling the magnitude of the non-contact force, the forced position of the glass and the flowability of the glass at high temperature, the non-uniformity of the thickness of the 3D glass object 8, especially in the bent area, can be overcome, after calculating the direction and magnitude of the force, an indirect contact pressure such as gas or plasma or magnetic force being applicable to the specific sections of the 2D glass substrate 1 according to the shape of the product so as to make the surface of the 2D glass substrate 1 tightly attached to the mold, further to form the 3D glass object 8, the 3D thermal molding equipment being a heating oven 3, the heating oven 3 having a silicon carbide heater 31, a vacuum thermal sucking module 32, a refractory protection layer 33, an IR temperature measurement unit 34, a nitrogen cooling device and a non-external-force-contact unit 35, the silicon carbide heater 31 being disposed on the upper and lower sides or left and right sides of the internal chamber of the heating oven 3, the heating temperature of the silicon carbide heater 31 ranging from 1000 to 1300 degree C., the refractory protection layer 33 being disposed on the wall face of the internal chamber of the heating oven 3 mainly for providing heat insulation and heat preservation effect and ensuring that the heating working temperature is kept within 800-1000 degree C., the refractory protection layer 33 being a ceramic fiber board or ceramic brick, the vacuum thermal sucking module 32 being disposed in the internal chamber of the heat oven 3 mainly for supporting the mold and providing gas sucking effect, the vacuum thermal sucking module 32 having a graphite plate 321 in alignment with multiple perforations 21 of the mold 2 for providing uniform thermal gas sucking and molding effect, the IR temperature measurement unit 34 being an infrared temperature measurement unit 34 disposed in the internal chamber of the heating oven 3, the IR temperature measurement unit 34 mainly serving to select a certain wavelength range (400˜1000 degree C.) according to the requirements of the manufacturing process of the glass and feed back the measured signal to the silicon carbide heater 31 for intelligent closed circuit control or connect with a computer for the computer to monitor, control and analyze the temperature curve, the material of the mold being a nickel-based superalloy containing 50˜55% nickel, 17˜21% chrome, 4.75˜55% niobium+tantalum, 2.8˜3.3% molybdenum and 0.65˜1.15% titanium, the surface of the mold 2 having multilayer vacuum coating of titanium aluminum nitride and aluminum trioxide as a protection layer to further prolong the lifetime of the mold, when the 2D glass substrate 1 is heated and softened to the annealing temperature, the thermal molding being performable, the gas being sucked through the perforations 21 of the mold 2, whereby the 2D glass substrate 1 is attached to the inner wall of the mold 2, the non-external-force-contact unit 35 being used to apply an indirect contact pressure such as gas or plasma or magnetic force to the 2D glass substrate 1 against the mold 2 so as to make the 2D glass substrate 1 more tightly attached to the inner surface of the mold 2, further to form the 3D glass object 8, in the molding and processing of the 3D glass object 8, a nitrogen cooling device (not shown) being used to provide inert gas so as to avoid oxidization reaction, the inert gas being nitrogen, also, the nitrogen serving to slowly cool the glass according to different characteristics of the glass; and

S3. taking out the molded 3D glass object 8 from the 3D thermal molding equipment 3, after the 2D glass substrate 1 is heated and thermally molded and cooled to form the 3D glass object 8, the molded 3D glass object 8 being taken out from the mold 2 to complete the manufacturing process of the 3D glass object 8.

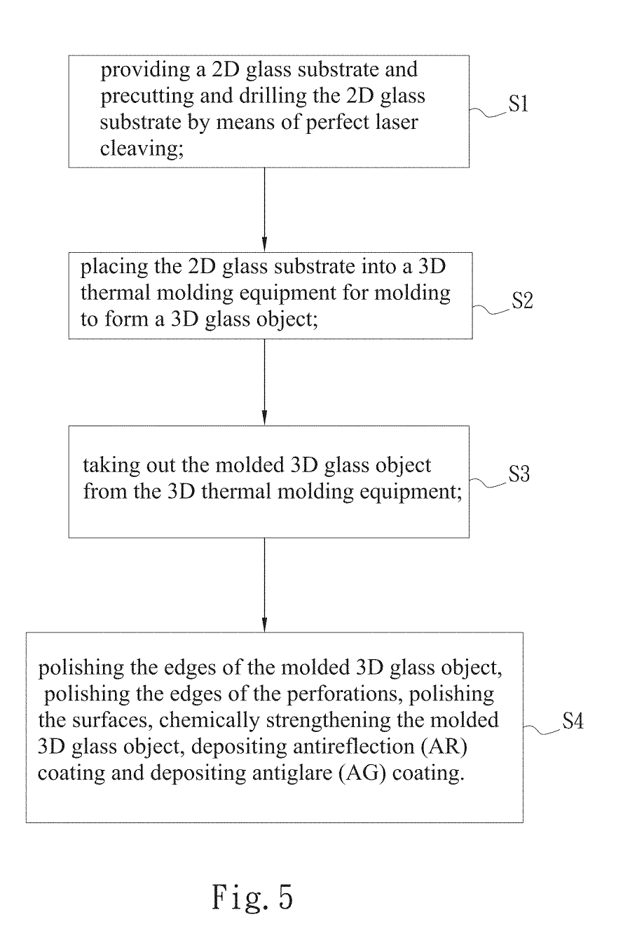

Please now refer to FIG. 5, which is a flow chart of a second embodiment of the manufacturing method of 3D glass of the present invention. According to the second embodiment, the manufacturing method of 3D glass of the present invention includes steps of:

S1. providing a 2D glass substrate 1 and precutting and drilling the 2D glass substrate 1 by means of perfect laser cleaving;

S2. placing the 2D glass substrate 1 into a 3D thermal molding equipment 3 for molding to form a 3D glass object 8; and

S3. taking out the molded 3D glass object 8 from the 3D thermal molding equipment 3.

The second embodiment is partially identical to the first embodiment in structure and technical characteristic and thus will not be repeatedly described hereinafter. The second embodiment is different from the first embodiment in that the second embodiment further includes a step of:

S4. polishing the edges of the molded 3D glass object 8, polishing the edges of the perforations, polishing the surfaces, chemically strengthening the molded 3D glass object 8, depositing antireflection (AR) coating and depositing antiglare (AG) coating.

The surfaces and edges of the molded 3D glass object 8 and the edges of the perforations 21 are trimmed by means of polishing. In addition, the surfaces are specially treated by means of chemical strengthening, deposition of antireflection (AR) coating and deposition of antiglare (AG) coating.

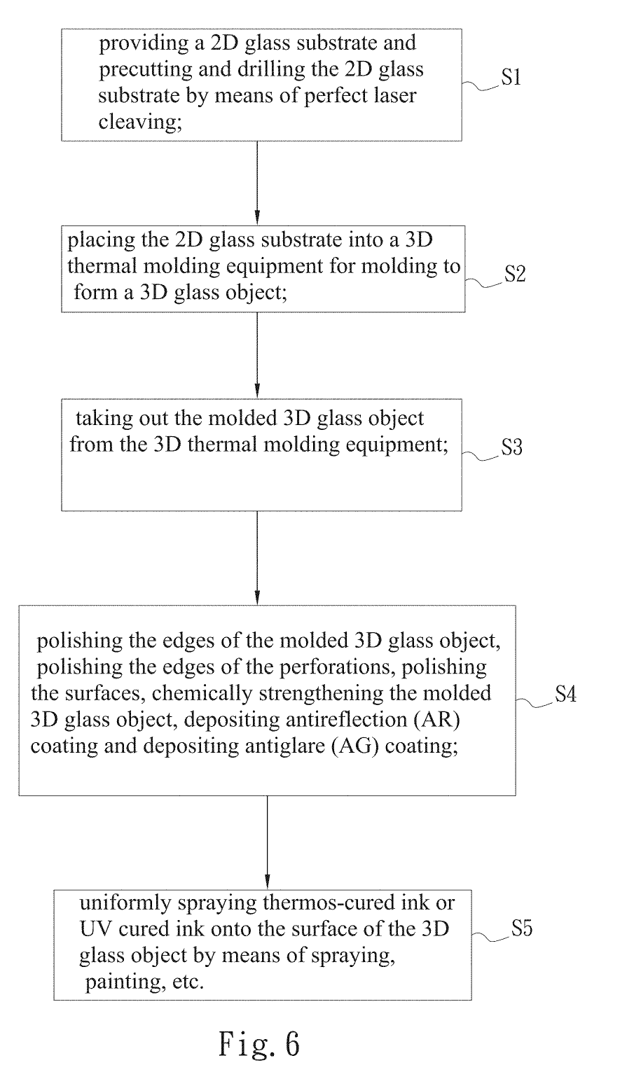

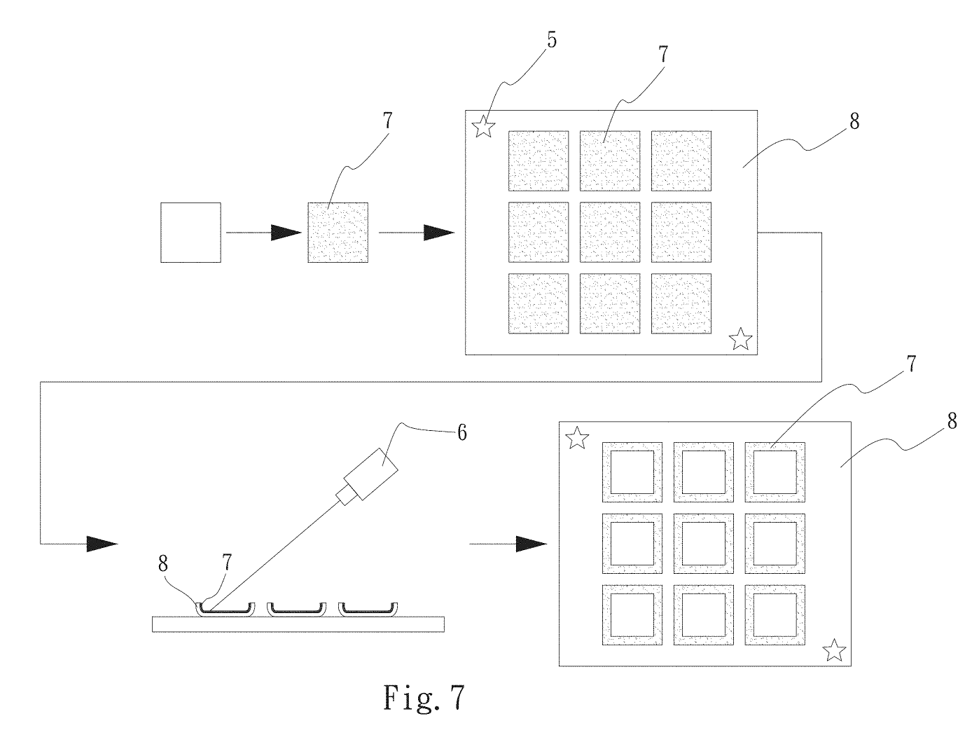

Please now refer to FIGS. 6 and 7. FIG. 6 is a flow chart of a third embodiment of the manufacturing method of 3D glass of the present invention. FIG. 7 is a schematic diagram showing the processing procedure of the third embodiment of the manufacturing method of 3D glass of the present invention. According to the third embodiment, the manufacturing method of 3D glass of the present invention includes steps of:

S1. providing a 2D glass substrate 1 and precutting and drilling the 2D glass substrate 1 by means of perfect laser cleaving;

S2. placing the 2D glass substrate 1 into a 3D thermal molding equipment 3 for molding to form a 3D glass object 8;

S3. taking out the molded 3D glass object 8 from the 3D thermal molding equipment 3; and

S4. polishing the edges of the molded 3D glass object 8, polishing the edges of the perforations, polishing the surfaces, chemically strengthening the molded 3D glass object 8, depositing antireflection (AR) coating and depositing antiglare (AG) coating.

The third embodiment is partially identical to the second embodiment in structure and technical characteristic and thus will not be repeatedly described hereinafter. The third embodiment is different from the second embodiment in that the third embodiment further includes a step of:

S5. uniformly spraying thermos-cured ink or UV cured ink onto the surface of the 3D glass object 8 by means of spraying, painting, etc.

Thermos-cured ink or UV cured ink 7 is uniformly sprayed onto the surface of the 3D glass object 8 by means of spraying, painting, etc. Then, the 3D glass object 8 is placed on a carrier with positioning marks 5. The positioning marks 5 or the edge of the 3D glass object 8 serves as a positioning point. The laser beam 6 is controlled to remove the unnecessary ink 7. Multiple 3D glass objects 8 can be treated (laser engraving) at a time in this step. After the 3D glass object 8 is taken from the carrier, 3D glass object 8 will have decorative ink/photoresistant.

The above manufacturing process can be performed by a complex equipment to process, such as expose or laser-engrave multiple 3D glass objects 8 at a time. The coordinate of the positioning marks on the carrier or the edge of the 3D glass object 8 is identified and calculated by CCD system to expose or laser-engrave those sections necessitating processing.

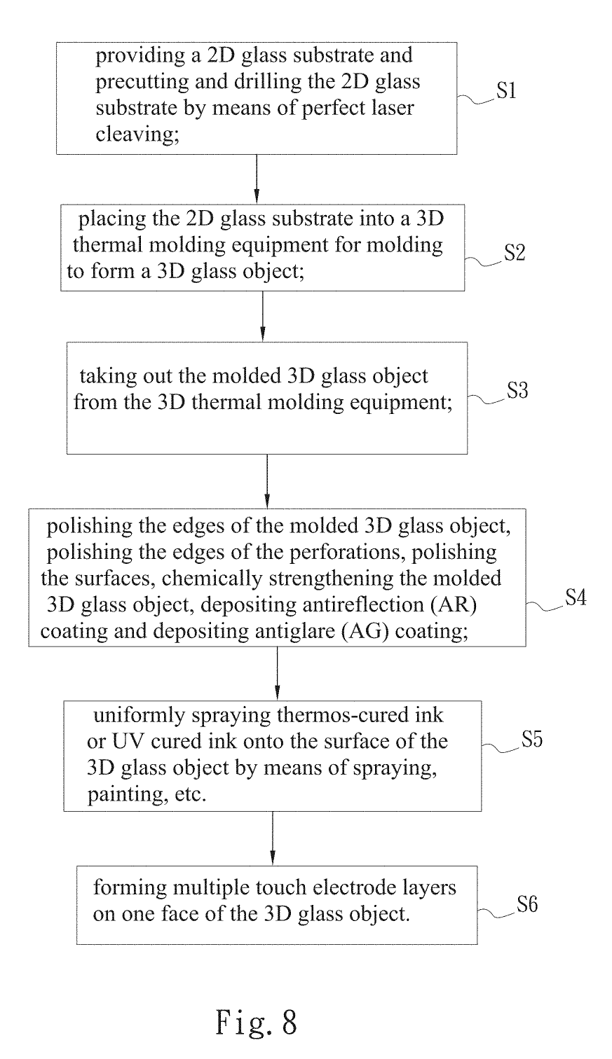

Please now refer to FIG. 8, which is a flow chart of a fourth embodiment of the manufacturing method of 3D glass of the present invention. According to the fourth embodiment, the manufacturing method of 3D glass of the present invention includes steps of:

S1. providing a 2D glass substrate 1 and precutting and drilling the 2D glass substrate 1 by means of perfect laser cleaving;

S2. placing the 2D glass substrate 1 into a 3D thermal molding equipment 3 for molding to form a 3D glass object 8;

S3. taking out the molded 3D glass object 8 from the 3D thermal molding equipment 3;

S4. polishing the edges of the molded 3D glass object 8, polishing the edges of the perforations, polishing the surfaces, chemically strengthening the molded 3D glass object 8, depositing antireflection (AR) coating and depositing antiglare (AG) coating; and

S5. uniformly spraying thermos-cured ink or UV cured ink onto the surface of the 3D glass object 8 by means of spraying, painting, etc.

The fourth embodiment is partially identical to the first embodiment in structure and technical characteristic and thus will not be repeatedly described hereinafter. The fourth embodiment is different from the first embodiment in that the fourth embodiment further includes a step of:

S6. forming multiple touch electrode layers on one face of the 3D glass object 8.

The touch electrode layers include a first electrode layer, a second electrode layer, a wiring layer, a shield layer and at least one insulation layer. These layers are laminated. The touch electrode layer pertains to prior art and thus will not be further described hereinafter.

Multiple touch electrode layers are formed on one face of the 3D glass object 8 mainly by means of lithography or printing or 3D laser-engraving. The 3D laser exposure process can be performed by a complex equipment to process, such as expose or laser-engrave multiple 3D glass objects 8 at a time. The coordinate of the positioning marks on the carrier or the edge of the 3D glass object 8 is identified and calculated by CCD system to expose or laser-engrave those sections necessitating processing.

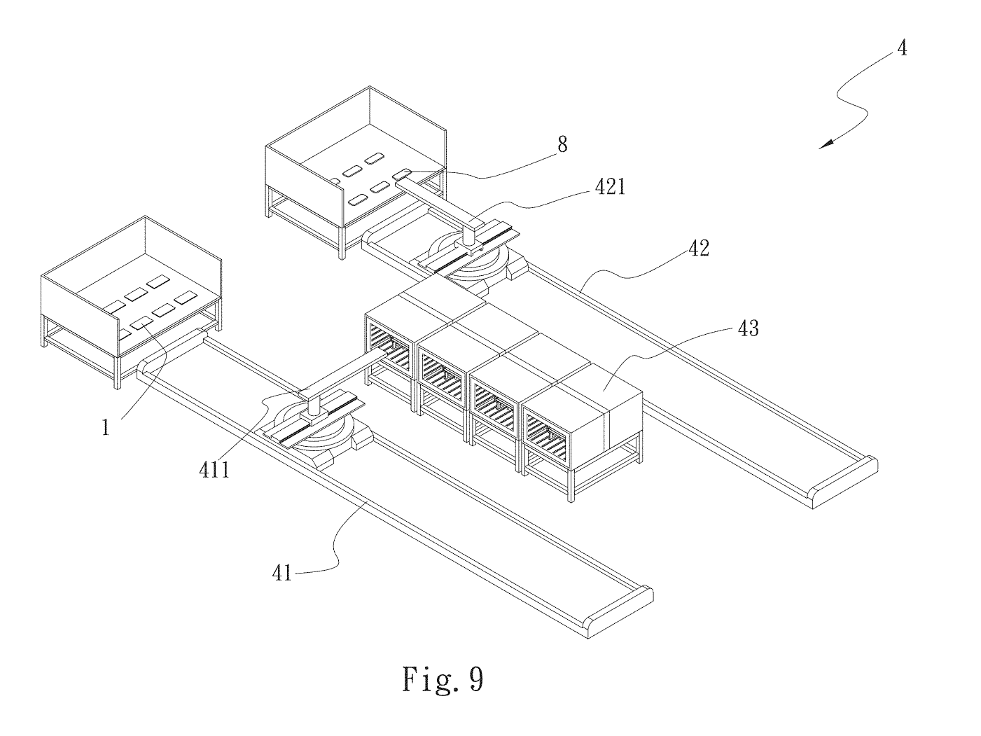

Please now refer to FIG. 9, which is a schematic diagram of a fifth embodiment of the manufacturing method of 3D glass of the present invention. According to the fifth embodiment, the manufacturing method of 3D glass of the present invention is fully automated. The full automation equipment 4 has a first conveying assembly 41, a second conveying assembly 42 and multiple heating ovens 43. The first and second conveying assemblies 41, 42 are respectively disposed on two sides of the heat ovens 43. The first conveying assembly 41 further has a first conveying robotic arm 411 and the second conveying assembly 42 further has a second conveying robotic arm 421. The first conveying robotic arm 411 first conveys the 2D glass substrates 1 to be processed and molded into the heating ovens 43 for heating and molding. After the process is completed, the second conveying assembly 42 of the second conveying assembly 42 takes the 3D glass objects 8 out of the heating ovens 43 and conveys the 3D glass objects 8 to the next working area.

By means of the manufacturing method of 3D glass of the present invention, the shortcoming of the conventional manufacturing method of handheld or mobile device that the structure is apt to break and damage to reduce the structural strength is improved. In addition, the defect-free rate is increased.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A manufacturing method of 3D glass, comprising steps of:
providing a 2D glass substrate and precutting and drilling the 2D glass substrate by means of perfect laser cleaving;
placing the 2D glass substrate into a 3D thermal molding equipment for molding to form a 3D glass object; and
taking out the molded 3D glass object from the 3D thermal molding equipment.

2. The manufacturing method of 3D glass as claimed in claim 1, wherein in the molding and processing process of the 3D glass object, an inert gas is provided to avoid oxidization reaction, the inert gas being nitrogen, the nitrogen also serving to slowly cool the 3D glass object according to different characteristics of the 3D glass object.

3. The manufacturing method of 3D glass as claimed in claim 1, wherein the material of the mold is a nickel-based superalloy containing 50˜55% nickel, 17˜21% chrome, 4.75˜55% niobium tantalum, 2.8˜3.3% molybdenum and 0.65˜1.15% titanium.

4. The manufacturing method of 3D glass as claimed in claim 1, further comprising a mold, the mold having a mold cavity and a surface of the mold cavity being provided with a coating of titanium aluminum nitride and a coating of aluminum trioxide.

5. The manufacturing method of 3D glass as claimed in claim 1, wherein the 3D thermal molding equipment for heating the glass substrate has a silicon carbide heater, a vacuum thermal sucking module, a refractory protection layer, an IR temperature measurement unit, a nitrogen cooling device and a mold, the silicon carbide heater being disposed on upper and lower sides or left and right sides of an internal chamber of the heating oven, the heating temperature of the silicon carbide heater ranging from 1000 to 1300 degree C., the refractory protection layer being disposed on a wall face of the internal chamber of the heating oven mainly for providing heat insulation and heat preservation effect and ensuring that the heating working temperature is kept 1000 degree C., the refractory protection layer being a ceramic fiber board or ceramic brick, the vacuum thermal sucking module being disposed in the internal chamber of the heat oven mainly for supporting the mold and providing gas sucking effect, the vacuum thermal sucking module having a graphite plate in alignment with multiple perforations of the mold for providing uniform thermal gas sucking and molding effect, the IR temperature measurement unit being an infrared temperature measurement unit disposed in the internal chamber of the heating oven, the IR temperature measurement unit mainly serving to select a certain wavelength range (400˜1000 degree C.) according to the requirements of the manufacturing process of the glass and feed back the measured signal to the silicon carbide heater for intelligent closed circuit control or connect with a computer for the computer to monitor, control and analyze the temperature curve.

6. The manufacturing method of 3D glass as claimed in claim 1, further comprising a step of forming multiple touch electrode layers on one face of the 3D glass object, the touch electrode layers including a first electrode layer, a second electrode layer, a wiring layer, a shield layer and at least one insulation layer, these layers being laminated, the multiple touch electrode layers being formed on one face of the 3D glass object mainly by means of lithography or printing.

7. The manufacturing method of 3D glass as claimed in claim 1, wherein in the step of providing a 2D glass substrate and precutting and drilling the 2D glass substrate by means of perfect laser cleaving, the drilling process needs to cooperatively use common laser ablation to remove the residual material, the sort of laser including CW/Plus Type with a wavelength of UV (355 nm) or IR (1064 nm).

8. The manufacturing method of 3D glass as claimed in claim 1, wherein in the step of placing the 2D glass substrate into a 3D thermal molding equipment for molding to form the 3D glass object, the 3D thermal molding equipment molds the 2D glass substrate by means of vacuum sucking and non-contact force, with respect to those sections of the 3D glass object that have non-uniform thickness or the bent corner sections, a device being used to provide non-contact depressing force to tightly attach the glass to the mold, by means of controlling the magnitude of the non-contact force, the forced position of the glass and the flowability of the glass at high temperature, the non-uniformity of the thickness of the 3D glass object, especially in the bent area, be overcome.

9. The manufacturing method of 3D glass as claimed in claim 1, wherein in the step of placing the 2D glass substrate into a 3D thermal molding equipment for molding to form the 3D glass object, the 3D thermal molding equipment further has a mold, the surface of the mold being processed into sandblasted surface, hairline surface, laser stripes, various recessed/raised characters and logo.

10. The manufacturing method of 3D glass as claimed in claim 1, further comprising a step of uniformly spraying thermos-cured ink or UV cured ink onto the surface of the glass by means of spraying, painting, etc., a complex equipment being used to perform 3D laser exposure process to expose or laser-engrave multiple 3D glass objects at a time, the coordinate of the positioning marks on the carrier or the edge of the 3D glass object being identified and calculated by CCD system to expose or laser-engrave those sections necessitating processing.

11. The manufacturing method of 3D glass as claimed in claim 10, further comprising a step of polishing the edges of the molded 3D glass object, polishing the edges of the perforations, polishing the surfaces, chemically strengthening the molded 3D glass object, depositing antireflection (AR) coating and depositing antiglare (AG) coating.
